(19) United States
(12) Patent Application Publication
(10) Pub. No.: US 2016/0261013 A1
(43) Pub. Date: Sep. 8, 2016

(54) NONAQUEOUS ELECTROLYTE AIR BATTERY AND METHOD OF USE OF THE SAME

(71) Applicant: KABUSHIKI KAISHA TOYOTA CHUO KENKYUSHO, Nagakute-shi (JP)

(72) Inventors: Yoko HASE, Nagakute-shi (JP); Toru SHIGA, Nagakute-shi (JP)

(73) Assignee: KABUSHIKI KAISHA TOYOTA CHUO KENKYUSHO, Nagakute-shi (JP)

(21) Appl. No.: 15/012,299

(22) Filed: Feb. 1, 2016

(30) Foreign Application Priority Data
Mar. 4, 2015 (JP) 2015-042772

(51) Int. Cl. H01M 12/08; H01M 8/1004; H01M 10/0567; H01M 4/40; H01M 4/48; H01M 8/02; H01M 10/0525

(52) U.S. Cl. CPC H01M 12/08; H01M 8/02; H01M 8/1004; H01M 10/0525; H01M 4/405; H01M 4/48; H01M 10/0567; H01M 2004/028

(57) ABSTRACT

A nonaqueous electrolyte air battery 20 according to the present invention includes a negative electrode 21 having a negative electrode active material, a first positive electrode 22 including oxygen as a positive electrode active material, a nonaqueous electrolyte 26 which is in contact with the first positive electrode 22 and includes a compound having a structure containing a radical skeleton whose spin density measured by electron spin resonance spectroscopy is 10¹⁹ spins/g or more, and a second positive electrode 27 which is in contact with the nonaqueous electrolyte 26 and oxidizes the above compound. This first positive electrode 22 is to be connected when the nonaqueous electrolyte air battery 20 is discharged, and the second positive electrode 27 is to be connected when the nonaqueous electrolyte air battery 20 is charged.

### BACKGROUND OF THE INVENTION

1. Field of the Invention

The present invention relates to a nonaqueous electrolyte air battery and a method of use of the same.

2. Description of the Related Art

A lithium-air battery in which a stable radical compound (TEMPO), as a compound that can oxidatively decompose a discharge product by a chemical reaction, is dissolved in an electrolyte to promote a charging reaction has been proposed (refer to, for example, Non-Patent Literature 1). This lithium-air battery is described as having an improvement in at least one of discharging capacity, charging potential, and charging capacity.

### CITATION LIST

### Patent Literature

PTL 1: Journal of the American Chemical Society (J. Am Chem. Soc.), 136, 15054-15064, 2014

### SUMMARY OF THE INVENTION

Although the lithium-air battery of Non-Patent Literature 1 is described as being able to further improve charge/discharge characteristics, for example, in some cases, part of the stable radical compound (catalyst) may be chemically reduced by metallic lithium of the negative electrode. Furthermore, in some cases, the surface of the carbon positive electrode may be degraded by a side reaction occurring at the same time during electrochemical oxidative decomposition of the discharge product on the carbon positive electrode, i.e., during charging, resulting in deactivation of the catalyst.

The present invention has been achieved in view of such problems. It is a main object of the invention to provide a nonaqueous electrolyte air battery capable of further improving charge/discharge cycle characteristics and a method of use of the same.

The present inventors have performed thorough studies in order to achieve the above-mentioned object, and have found that, by separating a positive electrode that performs discharging from a positive electrode that performs charging, it is possible to further improve the charge/discharge cycle characteristics of a nonaqueous electrolyte air battery, thus completing the present invention.

That is, a nonaqueous electrolyte air battery according to the present invention includes a negative electrode having a negative electrode active material, a first positive electrode including oxygen as a positive electrode active material, a nonaqueous electrolyte which is in contact with the first positive electrode and includes a compound having a structure containing a radical skeleton whose spin density measured by electron spin resonance spectroscopy is 10¹⁹ spins/g or more, and a second positive electrode which is in contact with the nonaqueous electrolyte and oxidizes the compound.

A method of use of a nonaqueous electrolyte air battery according to the present invention is a method of use of a nonaqueous electrolyte air battery, the nonaqueous electrolyte air battery including a negative electrode having a negative electrode active material, a first positive electrode including oxygen as a positive electrode active material, a nonaqueous electrolyte which is in contact with the first positive electrode and includes a compound having a structure containing a radical skeleton whose spin density measured by electron spin resonance spectroscopy is 10¹⁹ spins/g or more, and a second positive electrode which is in contact with the nonaqueous electrolyte and oxidizes the compound, the method of use including discharging the nonaqueous electrolyte air battery by using the negative electrode and the first positive electrode, oxidizing the compound using the second positive electrode, and charging the nonaqueous electrolyte air battery by the oxidized compound.

In the nonaqueous electrolyte air battery and the method of use of the same according to the present invention, it is possible to further improve charge/discharge cycle characteristics. The reason for such an effect is assumed to be as follows. For example, in the present invention, by separating the electrode (first positive electrode) which carries out the discharge reaction of the nonaqueous electrolyte air battery from the electrode (second positive electrode) which charges (oxidizes) a redox catalyst (compound having a structure containing a radical skeleton; also referred to as the “stable radical compound”) dissolved in the nonaqueous electrolyte, it is possible to avoid oxidatively decomposing an oxide (e.g., lithium peroxide), which is a discharge product, directly on the first positive electrode. As a result, it is assumed that it is possible to suppress degradation of the first positive electrode and the stable radical compound (redox catalyst).

### BRIEF DESCRIPTION OF THE DRAWINGS

FIG. 1 is a schematic diagram showing an example of a nonaqueous electrolyte air battery 20 according to the present invention.

FIG. 2 is a schematic diagram showing an example of an F-type electrochemical cell 40.

FIG. 3 is a graph showing changes in the voltage and battery capacity in Experimental Example 1.

FIG. 4 is a graph showing changes in the voltage and battery capacity in a charging test in Experimental Example 2.

FIG. 5 is a graph showing changes in the voltage and battery capacity in a discharging test in Experimental Example 2.

FIG. 6 is a graph showing changes in the voltage and battery capacity in Experimental Example 3.

### DETAILED DESCRIPTION OF THE INVENTION

A nonaqueous electrolyte air battery according to the present invention includes a negative electrode having a negative electrode active material, a first positive electrode including oxygen as a positive electrode active material, a nonaqueous electrolyte which is in contact with the first positive electrode and includes a compound having a structure containing a radical skeleton whose spin density measured by electron spin resonance spectroscopy is 10¹⁹ spins/g or more (hereinafter also referred to as the “stable radical compound”), and a second positive electrode which is in contact with the nonaqueous electrolyte and oxidizes the stable radical compound. The negative electrode active material is not particularly limited as long as it can be used for an air battery. Hereinafter, for convenience of explanation, a description will be made on a nonaqueous electrolyte air battery which uses a negative electrode active material capable of occluding and releasing lithium. That is, a nonaqueous electrolyte lithium-air battery will be described.

In the nonaqueous electrolyte air battery according to the present invention, the negative electrode has a negative electrode active material. Preferably, the negative electrode active material can occlude and release lithium. Examples of the negative electrode active material capable of occluding and releasing lithium include metallic lithium, lithium alloys, metal oxides, metal sulfides, and carbonaceous materials that occlude and release lithium. Examples of lithium alloys include alloys of lithium with aluminum, tin, magnesium, indium, calcium, and the like. Examples of metal oxides include tin oxide, silicon oxide, lithium titanium oxide, niobium oxide, and tungsten oxide. Examples of metal sulfides include tin sulfide and titanium sulfide. Examples of carbonaceous materials that occlude and release lithium include graphite, coke, mesophase pitch-based carbon fibers, spheroidal carbon, and resin fired carbon.

In the nonaqueous electrolyte air battery according to the present invention, the first positive electrode uses oxygen from a gas as a positive electrode active material. The gas may be air or oxygen gas. The first positive electrode is an electrode to be connected when the nonaqueous electrolyte air battery is discharged. The first positive electrode may contain an electrically conductive material. The electrically conductive material is not particularly limited as long as it has electrical conductivity. An example of the electrically conductive material is carbon. The carbon may be carbon black, such as Ketjenblack, acetylene black, channel black, furnace black, lampblack, or thermal black; graphite, such as natural graphite (e.g., flake graphite), artificial graphite, or expanded graphite; activated carbon made from charcoal, coal, or the like; or carbon fibers obtained by carbonizing synthetic fibers, petroleum pitch materials, or the like. Furthermore, the electrically conductive material may be carbon paper; conductive fibers, such as metal fibers; metal powder, such as nickel powder or aluminum powder; or an organic conductive material, such as a polyphenylene derivative. These materials may be used alone or as a mixture of two or more of them. Furthermore, the first positive electrode may contain lithium oxide and lithium peroxide, which are discharge products. The first positive electrode is preferably porous.

In the nonaqueous electrolyte air battery according to the present invention, the first positive electrode may be formed by mixing an electrically conductive material, a binder, and the like, followed by press forming on a current collector. The current collector is preferably a porous body, such as a net or a mesh in order to diffuse oxygen rapidly, and may be a porous metal plate made of stainless steel, nickel, aluminum, or the like. Note that, in order to suppress oxidation, the surface of the current collector may be coated with a film made of an oxidation-resistant metal or alloy. Furthermore, a transparent electrically conductive material, such as InSnO₂, SnO₂, ZnO, or In₂O₃, or an impurity-doped material, such as fluorine-doped tin oxide (SnO₂:F), antimony-doped tin oxide (SnO₂:Sb), tin-doped indium oxide (In₂O₃:Sn), aluminum-doped zinc oxide (ZnO:Al), or gallium-doped zinc oxide (ZnO:Ga), may be deposited in a single layer or in multiple layers on a glass or polymer. The thickness thereof is not particularly limited, but is preferably 3 nm to 10 μm. The surface of the glass or polymer may be flat or may have irregularities.

In the nonaqueous electrolyte air battery according to the present invention, the second positive electrode is an electrode to be connected when the nonaqueous electrolyte air battery is charged. The second positive electrode is in contact with the nonaqueous electrolyte and oxidizes the stable radical compound contained therein. The second positive electrode is disposed in the nonaqueous electrolyte air battery, in a non-contact state with respect to the first positive electrode. The second positive electrode is not particularly limited as long as it has electrical conductivity, and may be composed of the same material as that of the first positive electrode or may be composed of a different material from that of the first positive electrode. The second positive electrode may be composed of a dense material. The nonaqueous electrolyte air battery may be configured such that, after discharging, the first positive electrode has an oxide generated by discharging, and during charging, the oxide, which is a discharge product, is decomposed by the stable radical compound which has been oxidized by charging using the second positive electrode. Furthermore, the second positive electrode may be disposed in the order of the negative electrode, the second positive electrode, and the first positive electrode, or in the order of the negative electrode, the first positive electrode, and the second positive electrode.

In the nonaqueous electrolyte air battery according to the present invention, as the nonaqueous electrolyte in contact with the first positive electrode and the second positive electrode, for example, a nonaqueous electrolyte containing a supporting salt can be used. The supporting salt is not particularly limited, and for example, a known supporting salt, such as LiPF₆, LiClO₄, LiAsF₆, LiBF₄, Li(CF₃SO₂)₂N, Li(CF₃SO₃), or LiN(C₂F₅SO₂)₂, can be used. These supporting salts may be used alone or in combination of two or more. The concentration of the supporting salt is preferably 0.1 to 2.0 M, and more preferably 0.8 to 1.2 M. As the nonaqueous electrolyte, an aprotic organic solvent can be used. Examples of such an organic solvent include a cyclic carbonate, a chain carbonate, a cyclic ester, a cyclic ether, and a chain ether. Examples of the cyclic carbonate include ethylene carbonate, propylene carbonate, butylene carbonate, and vinylene carbonate. Examples of the chain carbonate include dimethyl carbonate, diethyl carbonate, and methyl ethyl carbonate. Examples of the cyclic ester include gamma-butyrolactone and gamma-valerolactone. Examples of the cyclic ether include tetrahydrofuran and 2-methyltetrahydrofuran. Examples of the chain ether include dimethoxyethane and ethylene glycol dimethyl ether. These may be used alone or in combination of two or more. Furthermore, in addition to the compounds described above, it is also possible to use, as the nonaqueous electrolyte, a nitrile solvent, such as acetonitrile, propylnitrile, or 3-methoxypropionitrile; an ionic liquid, such as N-methyl-N-propyl piperidinium bis(trifluoromethanesulfonyl)imide, N,N,N-trimethyl-N-propyl ammonium bis(trifluoromethanesulfonyl)imide, or N,N-dimethyl-N-methyl-N-(2-methoxyethyl) ammonium bis(trifluoromethylsulfonyl)imide; a gel electrolyte; a solid electrolyte; or the like.

In the nonaqueous electrolyte air battery according to the present invention, the nonaqueous electrolyte includes a compound having a structure containing a stable radical skeleton. Here, the term “stable radical skeleton” refers to a skeleton that can be present as a radical for a long period of time. For example, the stable radical skeleton may have a spin density measured by electron spin resonance spectroscopy of 10¹⁹ spins/g or more, and preferably 10²¹ spins/g or more. The stable radical skeleton is, for example, preferably selected from the group including a skeleton having a nitroxyl radical, a skeleton having an oxy radical, a skeleton having a nitrogen radical, a skeleton having a carbon radical, and a skeleton having a boron radical. Specific examples thereof include skeletons having a nitroxyl radical represented by formulae (1) to (9), a skeleton having a phenoxy radical (oxy radical) represented by formula (10), skeletons having a hydrazyl radical (nitrogen radical) represented by formulae (11) to (13), and skeletons having a carbon radical represented by formulae (14) and (15). Among these, skeletons having a nitroxyl radical are particularly preferable. For example, the stable radical skeleton is preferably selected from the group including of a 2,2,6,6-tetraalkylpiperidine-1-oxyl skeleton (refer to formula (1)), a 2,2,5,5-tetraalkyl-1-oxylpyrrolinyl skeleton (refer to formula (2)), a 2,2,5,5-tetraalkyl-1-oxylpyrrolidinyl skeleton (refer to formula (3)), and a tert-butylphenylnitroxide skeleton (refer to formula (4)). In particular, a 2,2,6,6-tetramethylpiperidine-1-oxyl skeleton (refer to formula (1)) is more preferable. Furthermore, the stable radical compound may be a polymer or a monomolecular compound as long as it is soluble in the nonaqueous electrolyte. A monomolecular compound is uniformly dispersed when dissolved in the nonaqueous electrolyte, which is preferable.

In the nonaqueous electrolyte air battery according to the present invention, the stable radical compound in the nonaqueous electrolyte is not particularly limited as long as it can be dissolved in the electrolyte. For example, the stable radical compound may have a structure in which the stable radical skeleton is linked to at least one selected from hydrogen, an aromatic ring, an amino group, an alkyl group, an alkoxy group, a fluoroalkyl group, and a fluoroalkoxy group. In particular, a compound in which the stable radical skeleton is linked to at least one selected from hydrogen, an aromatic ring, an amino group, and an alkoxy group is preferable. An example of a compound in which the stable radical skeleton is linked to hydrogen is 2,2,6,6-tetramethylpiperidine-1-oxyl (compound A), which is preferable from the viewpoint of easy availability and the like. An example of a compound in which the stable radical skeleton is linked to an aromatic ring is N-(3,3,5,5-tetramethyl-4-oxylpiperidyl)pyrene-1-carboxyamide (compound B), which is preferable from the viewpoint that the radical is more stable. Furthermore, an example of a compound in which the stable radical skeleton is linked to an amino group is 4-amino-2,2,6,6-tetramethylpiperidine-1-oxyl (compound C), which is preferable because of a lower charging potential. Furthermore, an example of a compound in which the stable radical skeleton is linked to an alkoxy group is 4-methoxy-2,2,6,6-tetramethylpiperidine-1-oxyl (compound D). The aromatic ring may be monocyclic or polycyclic. The polycyclic aromatic ring is preferably selected from the group including naphthalene, phenalene, triphenylene, anthracene, perylene, phenanthrene, and pyrene. Pyrene is particularly preferable. The atomic group, such as hydrogen, an aromatic ring, an amino group, an alkyl group, an alkoxy group, a fluoroalkyl group, or a fluoroalkoxy group, may be linked to the radical skeleton with a spacer therebetween, the spacer being selected from the group including of an amide bond, an ester bond, a urea bond, a urethane bond, a carbamide bond, an ether bond, and a sulfide bond. The atomic group may be directly linked to the radical skeleton without such a spacer, but is preferably linked to the radical skeleton with the spacer therebetween from the viewpoint of easy synthesis. Furthermore, an alkyl chain may be present between the atomic group and the spacer, and an alkyl chain may be present between the radical skeleton and the spacer. One atomic group may be linked to one radical skeleton. Alternatively, a plurality of atomic groups may be linked to one radical skeleton. In this case, the plurality of atomic groups may be the same, may be different, or may be partially the same and partially different. Alternatively, one atomic group may be linked to a plurality of radical skeletons. In this case, the plurality of radical skeletons may be the same, may be different, or may be partially the same and partially different. The radical skeleton may have a single radical or a plurality of radicals within the skeleton.

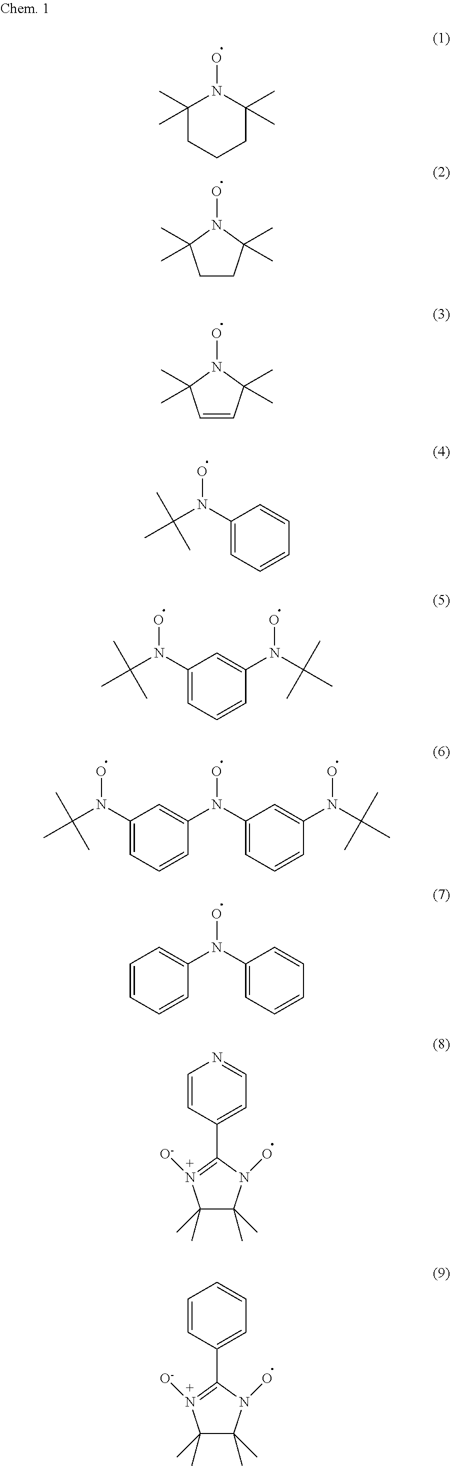

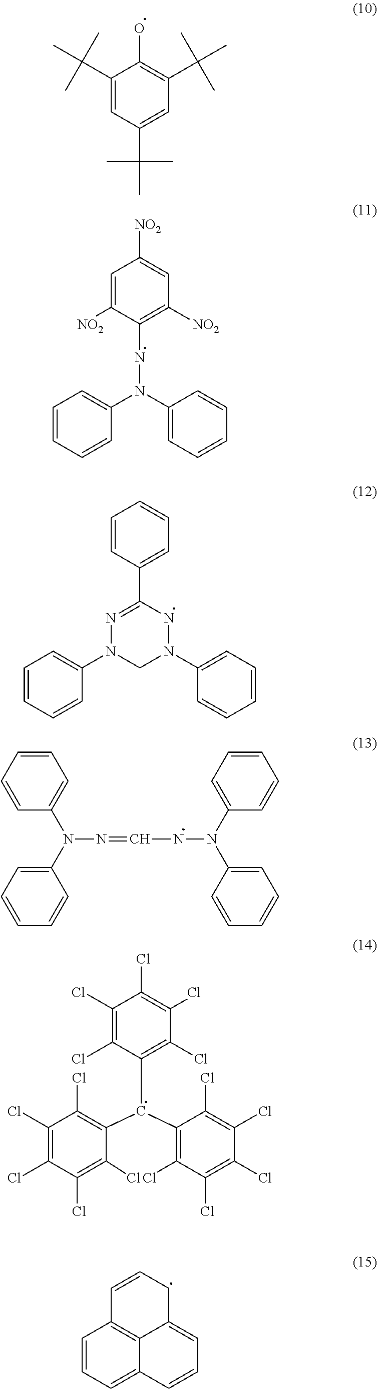

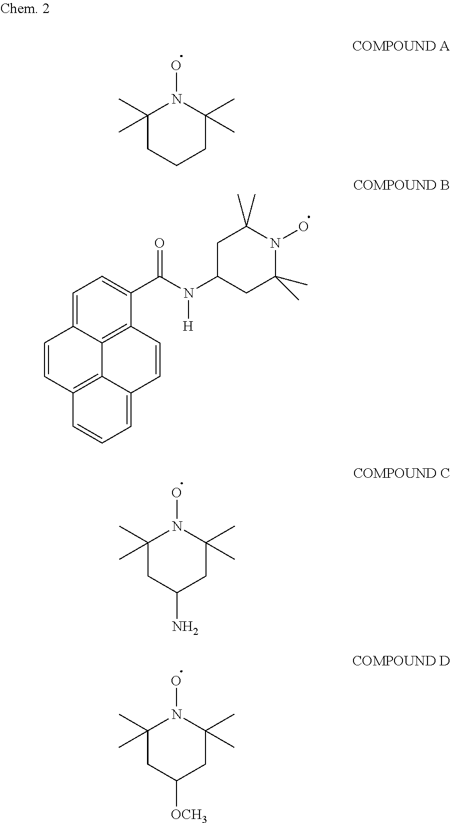

In the nonaqueous electrolyte air battery according to the present invention, in the case where the stable radical compound is a monomolecular compound, the nonaqueous electrolyte contains the stable radical compound preferably in an amount of 0.01 to 0.25 mmol, and more preferably in an amount of 0.018 to 0.25 mmol. When the amount of the stable radical compound is 0.01 mmol or more, the effect of decreasing the charging potential can be obtained. When the amount of the stable radical compound is 0.25 mmol or less, it is possible to suppress the influence on other components (e.g., a supporting salt) contained in the electrolyte, and it is possible to reduce costs, which is also preferable. In the case where the amount of the electrolyte is about 5 mL, the content of the stable radical compound is preferably in the range of 0.002 to 0.05 mol/L, and more preferably in the range of 0.0036 to 0.05 mol/L. On the other hand, in the case where the amount of the electrolyte is less than 5 mL, it is preferable to prioritize ensuring the absolute amount of the stable radical compound (0.01 to 0.25 mmol). In the case where the stable radical compound is a polymer compound, the amount of the stable radical compound is preferably 0.001% to 10% by mass relative to the total mass of the nonaqueous electrolyte. When the amount of the stable radical compound is 0.001% by mass or more, the effect of decreasing the charging potential can be sufficiently obtained. When the amount of the stable radical compound is 10% by mass or less, it is possible to suppress the influence on other components (e.g., a supporting salt) contained in the nonaqueous electrolyte.

In the nonaqueous electrolyte air battery according to the present invention, a separator may be provided between the negative electrode and the first positive electrode. As the separator, any material having a composition that can withstand use in nonaqueous electrolyte air batteries can be used without particular limitations. Examples thereof include polymer nonwoven fabrics, such as a polypropylene nonwoven fabric and a polyphenylene sulfide nonwoven fabric; and microporous films composed of an olefin resin, such as polyethylene or polypropylene. These may be used alone or in combination.

In the nonaqueous electrolyte air battery according to the present invention, a solid electrolyte may be provided between the first and the second positive electrodes and the negative electrode. In such a manner, it is possible to separate the positive electrode side and the negative electrode side, which is preferable from the viewpoint of further improving charge/discharge cycle characteristics of the nonaqueous electrolyte air battery. The solid electrolyte is not particularly limited as long as it can conduct ions which are carriers. For example, in the case where lithium ions are carriers, as the solid electrolyte, a glass ceramic LICGC (OHARA Corporation) or the like may be used. Other examples that can be used include solid electrolytes presented in Japanese Unexamined Patent Application Publication No. 2009-122991, such as garnet-type oxide Li₅₊ₓLa₃ (Zrₓ,Nb₂₋ₓ)O₁₂ (1.4≦X<2), garnet-type oxide Li₇La₃Zr₂O₁₂, garnet-type oxide Li₇ALa₃Nb₂O₁₂ (A=Ca, Sr, Ba), and glass ceramic Li_{1.5}Al_{0.5}Ge_{1.5}(PO₄)₃ (LAGP).

In the nonaqueous electrolyte air battery provided with a solid electrolyte according to the present invention, the nonaqueous electrolyte containing a stable radical compound is interposed between the first and the second positive electrodes and the solid electrolyte. Furthermore, an ion-conducting medium which does not contain a stable radical compound may be interposed between the negative electrode and the solid electrolyte. In such a manner, the stable radical compound and the negative electrode can be prevented from being brought into contact with each other, and therefore, it is possible to further suppress degradation of the stable radical compound and the like. As the ion-conducting medium, any nonaqueous electrolyte exemplified above can be used as long as it conducts ions which are carriers. The ion-conducting medium may be the same as or different from the nonaqueous electrolyte containing a stable radical compound. Furthermore, in the case where the negative electrode is metallic lithium or the like, as long as the solid electrolyte is stable with respect to the negative electrode, the negative electrode and the solid electrolyte may be directly joined to each other.

The shape of the nonaqueous electrolyte air battery according to the present invention is not particularly limited. For example, the nonaqueous electrolyte air battery may be coin-shaped, button-shaped, sheet-shaped, laminate-shaped, cylindrical, flat, square-shaped, or the like. Furthermore, the nonaqueous electrolyte air battery may be applied to a large battery used for an electric car or the like.

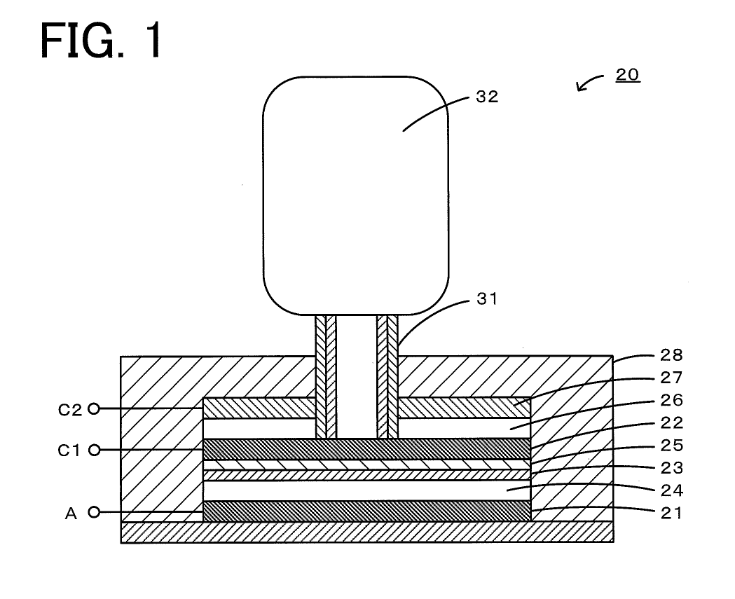

FIG. 1 is a schematic diagram showing an example of a nonaqueous electrolyte air battery 20 according to the present invention. The nonaqueous electrolyte air battery 20 includes a negative electrode 21 having a negative electrode active material, a first positive electrode 22 including oxygen as a positive electrode active material, and a disposed between the negative electrode 21 and the first positive electrode 22. An ion-conducting medium 24 that conducts lithium ions is provided between the negative electrode 21 and the separator 23, and a solid electrolyte layer 25 that conducts lithium ions is disposed between the first positive electrode 22 and the separator 23. A second positive electrode 27 is disposed on the upper side of the first positive electrode 22 (on the opposite surface side to the surface on which the solid electrolyte layer 25 is disposed) in a non-contact state with respect to the first positive electrode 22. A nonaqueous electrolyte 26 that conducts lithium ions is provided between the first positive electrode 22 and the second positive electrode 27. A terminal A is connected to the negative electrode 21, a terminal C1 is connected to the first positive electrode 22, and a terminal C2 is connected to the second positive electrode 27. The nonaqueous electrolyte air battery 20 includes a casing 28, a pressing member 31, and a gas reservoir 32. The casing 28 is a container made of an insulator configured to contain the negative electrode 21, the first positive electrode 22, and the second positive electrode 27. The pressing member 31 is a member that presses the first positive electrode 22, and oxygen can be passed through inside thereof. The gas reservoir 32 contains oxygen-containing gas (e.g., dry air), and is configured to supply oxygen through the pressing member 31 to the first positive electrode 22. In the first positive electrode 22, an external load is connected to the terminal C1 during discharging of the nonaqueous electrolyte air battery 20, and the first positive electrode 22 has an oxide generated by discharging. In the second positive electrode 27, charging equipment is connected to the terminal C2 during charging of the nonaqueous electrolyte air battery 20, and the second positive electrode 27 is in contact with the nonaqueous electrolyte 26 and oxidizes a stable radical compound contained in the nonaqueous electrolyte 26. The nonaqueous electrolyte 26 is in contact with the first positive electrode 22 and the second positive electrode 27, and contains a stable radical compound. The ion-conducting medium 24 is a nonaqueous electrolyte that does not contain the stable radical compound, and conducts lithium ions.

In a method of use of a nonaqueous electrolyte air battery according to the present invention, the nonaqueous electrolyte air battery to be used includes a negative electrode having a negative electrode active material, a first positive electrode including oxygen as a positive electrode active material, a nonaqueous electrolyte which is in contact with the first positive electrode and includes a stable radical compound, and a second positive electrode which is in contact with the nonaqueous electrolyte and oxidizes the stable radical compound. In the method of use, the nonaqueous electrolyte air battery is discharged by using the negative electrode and the first positive electrode, the stable radical compound is oxidized using the second positive electrode, and the nonaqueous electrolyte air battery is charged by the oxidized compound. In the method of use, preferably, after the stable radical compound is oxidized using the second positive electrode, the nonaqueous electrolyte air battery is held (left to stand) for a period of 2 to 24 hours, and the nonaqueous electrolyte air battery is charged by the oxidized stable radical compound. Since the nonaqueous electrolyte air battery is held in such a manner, the oxide, which is a discharge product, can be sufficiently decomposed by the stable radical compound. The holding time is preferably 20 hours or less, and more preferably 12 hours or less. Furthermore, the temperature at which the nonaqueous electrolyte air battery is held is, for example, preferably −10° C. to 40° C., more preferably 15° C. to 35° C., and still more preferably room temperature (20° C. to 25° C.).

In the nonaqueous electrolyte air battery and the method of use of the same according to the present invention, which have been described above in detail, it is possible to further improve charge/discharge cycle characteristics. The reason for such an effect is assumed to be as follows. For example, in the present invention, by separating the electrode (first positive electrode) which carries out the discharge reaction of the nonaqueous electrolyte air battery from the electrode (second positive electrode) which charges (oxidizes) a redox catalyst (compound having a structure containing a radical skeleton; also referred to as the “stable radical compound”) dissolved in the nonaqueous electrolyte, it is possible to avoid oxidatively decomposing an oxide (e.g., lithium peroxide), which is a discharge product, directly on the first positive electrode. As a result, it is assumed that it is possible to suppress degradation of the first positive electrode and the stable radical compound (redox catalyst).

It is to be understood that the present invention is not limited to the embodiments described above, and various modifications are possible within the technical scope of the present invention.

For example, in the embodiments described above, a description has been made on the lithium-air battery which uses a negative electrode active material capable of occluding and releasing lithium. However, the negative electrode active material is not particularly limited as long as it can be used in air batteries.

### EXAMPLES

An example in which a nonaqueous electrolyte air battery according to the present invention is specifically fabricated will be shown below as an experimental example. Note that Experimental Example 2 corresponds to an example of the preset invention, Experimental Example 3 corresponds to a comparative example, and Experimental Example 1 corresponds to a reference example.

### Experimental Example 1

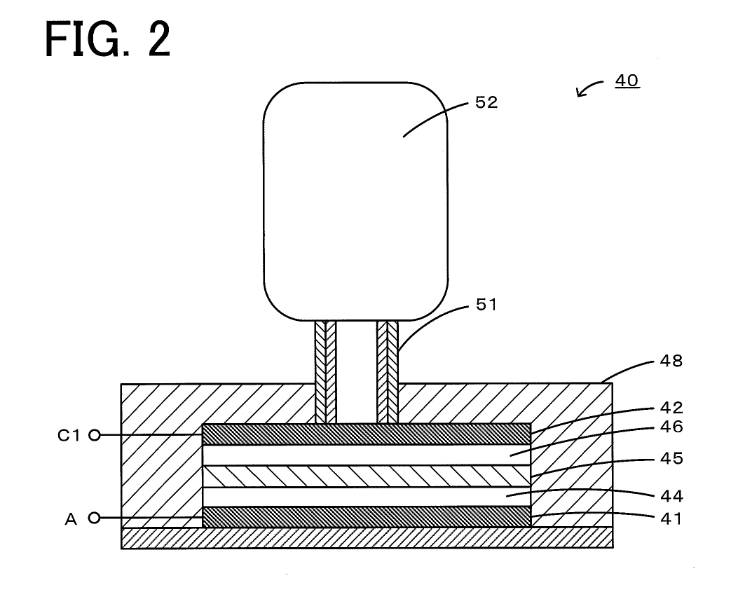

Carbon paper (manufactured by Toray, TGP-H-060) was cut into a piece with a weight of 20 mg and used as a positive electrode of a nonaqueous electrolyte lithium-air battery. Metallic lithium (manufactured by Tanaka Kikinzoku) with a diameter of 10 mm and a thickness of 0.5 mm was used as a negative electrode. An electrochemical evaluation cell 40 shown in FIG. 2 was fabricated using these components. First, a negative electrode 41 was placed in a casing 48 made of SUS, and a lithium-conducting solid electrolyte 45 (manufactured by OHARA) was placed between a positive electrode 42 and the negative electrode 41. A nonaqueous electrolyte 44 (electrolyte A) in an amount of 5 mL was injected between the negative electrode 41 and the solid electrolyte 45. As the electrolyte A, a solution composed of 30 parts by mass of ethylene carbonate and 70 parts by mass of diethyl carbonate containing 1 M lithium bis(trifluoromethanesulfonyl)imide as a supporting salt (manufactured by Kanto Chemical Co., Inc.) was used. Next, by dissolving 3.26 g of lithium bis(trifluoromethylsulfonyl)imide, as a supporting salt, in 25 mL of N,N-dimethyl-N-methyl-N-(2-methoxyethyl)ammonium bis (trifluoromethylsulfonyl)imide (DEME-TFSI), 0.32 mol/kg of a nonaqueous electrolyte was prepared (electrolyte B). By dissolving 55.88 mg of 4-methoxy-2,2,6,6-tetramethylpiperidine-1-oxyl free radical (MeO-TEMPO; compound D), as a redox catalyst, in 3.00 mL of the nonaqueous electrolyte, a nonaqueous electrolyte 46 (electrolyte C) with a catalyst concentration of 0.1 M was prepared. The electrolyte C in an amount of 1 mL was injected between the solid electrolyte 45 and the positive electrode 42. By pressing the positive electrode 42 from above with a pressing member 51 through which air can be passed, the cell was immobilized. A gas reservoir 52 was connected to the upper side of the pressing member 51. Thereby, a lithium-air battery of Experimental Example 1 was obtained. Although not shown, the casing 48 can be separated into an upper portion in contact with the positive electrode 42 and a lower portion in contact with the negative electrode 41, and an insulating resin is interposed between the upper portion and the lower portion. Thereby, the positive electrode 42 and the negative electrode 41 are electrically isolated from each other.

The electrochemical evaluation cell thus obtained was set in a charging/discharging unit (Model 5V/100 MA) manufactured by Aska Electronic Co., Ltd., and discharging was performed with a current flow of 0.003 mA between the positive electrode and the negative electrode until the discharge potential became 2.0 V or less. Subsequently, charging was performed with a current flow of 0.003 mA between the positive electrode and the negative electrode until the open-end voltage reached 4.0 V. This discharging and charging test was conducted at 25° C.

### Experimental Example 2

By performing charging using the electrochemical evaluation cell 40 shown in FIG. 2, all of the stable radical compound (redox catalyst) contained in the electrolyte C was oxidized. The resulting solution was diluted with the electrolyte B so that the concentration was set at 0.01 M (electrolyte D). Separately, an electrochemical evaluation cell was fabricated as in Experimental Example 1, and after discharging was performed as in Experimental Example 1, the electrolyte C in the cell was replaced with 0.2 mL of the electrolyte D. The cell was held for 2 to 20 hours at 25° C., and then discharging was performed again as in Experimental Example 1. In Experimental Example 2, the cycle consisting of discharging, replacement of the nonaqueous electrolyte, and holding of the battery cell described above was repeated. In Experimental Example 2, since the positive electrode (first positive electrode) that generates a discharge product during discharging is separated from the positive electrode (second positive electrode) that oxidizes the redox catalyst during charging, it is possible to reproduce the function of the first positive electrode and the second positive electrode of the battery cell shown in FIG. 1.

### Experimental Example 3

The charging and discharging test was conducted as in Experimental Example 1 except that 1 mL of the electrolyte B was injected between the solid electrolyte and the positive electrode. In Experimental Example 3, the nonaqueous electrolyte 46 does not contain a stable radical compound (redox catalyst).

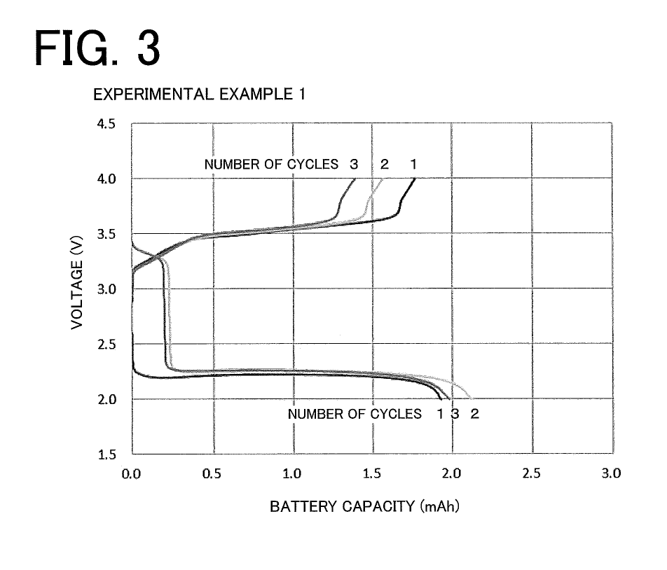

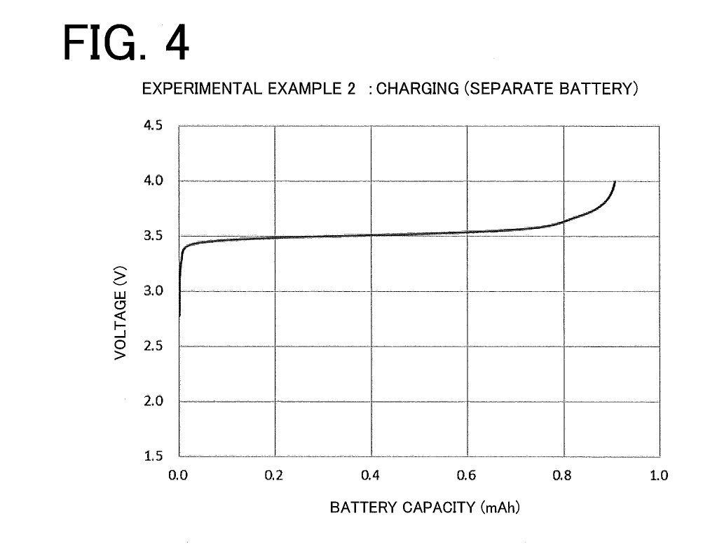

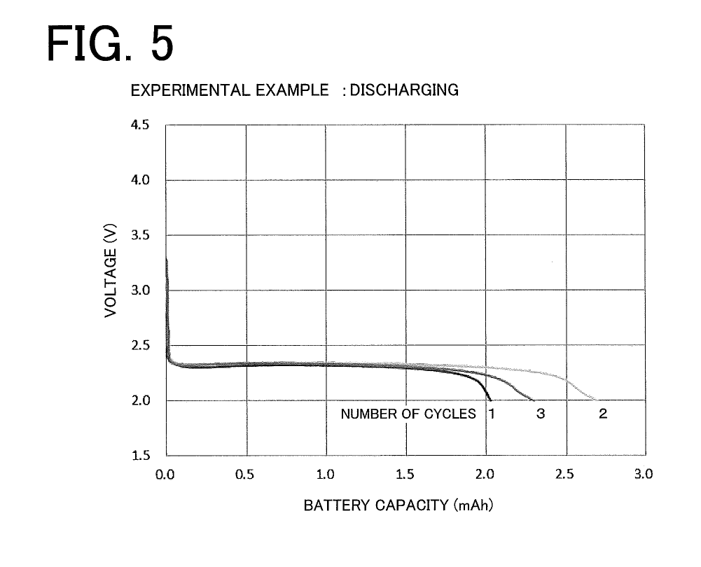

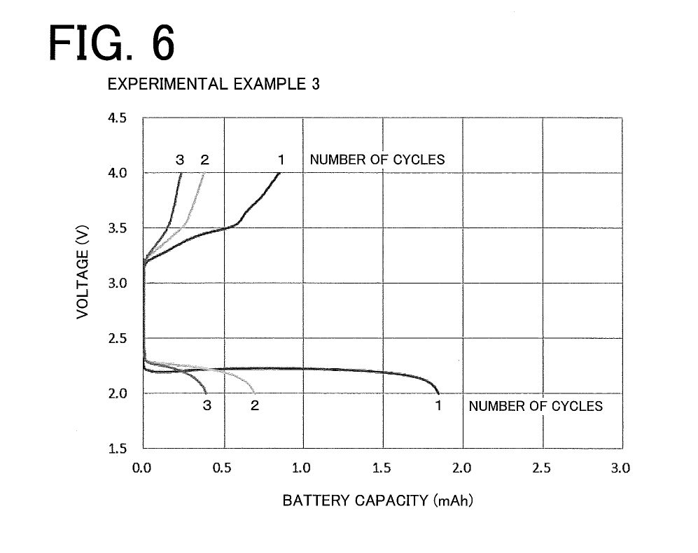

FIGS. 3, 5, and 6 are graphs showing changes in the voltage and battery capacity in the discharging and charging test in Experimental Examples 1 to 3. FIG. 4 is a graph showing changes in the voltage and battery capacity when charging was performed using the electrolyte C in Experimental Example 2. Table 1 summarizes the structure, the charging treatment, and the discharge capacity (mAh) at the third cycle in Experimental Examples 1 to 3. The results show that the lithium-air batteries including the nonaqueous electrolyte that contains a stable radical compound, which is a redox catalyst, (Experimental Examples 1 and 2) have a lower average voltage and a higher charging capacity in the charging reaction, in comparison with Experimental Example 3 in which the nonaqueous electrolyte does not contain a redox catalyst. Furthermore, in Experimental Example 2, the nonaqueous electrolyte is replaced with a nonaqueous electrolyte containing a stable radical compound which has been oxidized using the separate positive electrode (electrochemical evaluation cell), and the discharge product (lithium oxide) deposited on the positive electrode is decomposed by the oxidized stable radical compound. In Experimental Example 2, since the discharge product on the positive electrode 42 is decomposed by the stable radical compound (redox catalyst), the discharge product is not electrochemically decomposed, for example, by discharging treatment. Therefore, deactivation of the redox catalyst is suppressed, and the discharge capacity is higher than that of Experimental Example 1. Moreover, in Experimental Example 2, even when the number of charge/discharge cycles exceeds 10, the decrease in battery capacity is suppressed. Thus, it has become obvious that higher charge/discharge cycle characteristics are obtained. As described above, it has been found that by separating a positive electrode used during discharging from a positive electrode used during charging, it is possible to further improve the charge/discharge cycle characteristics of a nonaqueous electrolyte lithium-air battery. Furthermore, in this example, the first positive electrode and the second positive electrode are placed in different cells. However, even when a cell including both a first positive electrode and a second positive electrode, such as the one shown in FIG. 1, is used, it is assumed that the same effects as those in the example described above are achieved.

TABLE 1

| | STABLE RADICAL | | DISCHARGE |
|---|---|---|---|
| | COMPOUND | | CAPACITY |
| | CONTAINED | | (mAh) AT |
| | IN NONAQUEOUS | CHARGING | THE THIRD |
| | ELECTROLYTE | TREATMENT | CYCLE |
| EXPERIMEN- | MeO-TEMPO | NORMAL | 1.98 |
| TAL EXAM- | | CHARGING | |
| PLE 1 | | | |
| EXPERIMEN- | MeO-TEMPO | CHARGING | 2.26 |
| TAL EXAM- | | BY SEPA- | |
| PLE 2 | | RATE CELL | |
| EXPERIMEN- | NOT | NORMAL | 0.40 |
| TAL EXAM- | CONTAINED | CHARGING | |
| PLE 3 | | | |

The present application claims priority from Japanese Patent Application No. 2015-042772 filed on Mar. 4, 2015, the entire contents of which are incorporated herein by reference.

What is claimed is:

1. A nonaqueous electrolyte air battery including:
a negative electrode having a negative electrode active material,
a first positive electrode including oxygen as a positive electrode active material,
a nonaqueous electrolyte which is in contact with the first positive electrode and includes a compound having a structure containing a radical skeleton whose spin density measured by electron spin resonance spectroscopy is 10¹⁹ spins/g or more, and
a second positive electrode which is in contact with the nonaqueous electrolyte and oxidizes the compound.

2. The nonaqueous electrolyte air battery according to claim 1,
wherein the first positive electrode is to be connected when the nonaqueous electrolyte air battery is discharged, and
the second positive electrode is to be connected when the nonaqueous electrolyte air battery is charged.

3. The nonaqueous electrolyte air battery according to claim 1, wherein, after discharging, the first positive electrode has an oxide generated by discharging, and during charging, the oxide is decomposed by the compound which has been oxidized by charging using the second positive electrode.

4. The nonaqueous electrolyte air battery according to claim 1, wherein the nonaqueous electrolyte includes the compound having the structure containing the radical skeleton being at least one selected from the group including of a skeleton having a nitroxyl radical, a skeleton having an oxy radical, a skeleton having a nitrogen radical, and a skeleton having a carbon radical.

5. The nonaqueous electrolyte air battery according to claim 1, wherein the nonaqueous electrolyte includes the compound having the structure containing 2,2,6,6-tetramethylpiperidine-1-oxyl as the radical skeleton.

6. The nonaqueous electrolyte air battery according to claim 1, including a solid electrolyte which is provided between the first and the second positive electrodes and the negative electrode,
wherein the nonaqueous electrolyte is interposed between the first and the second positive electrodes and the solid electrolyte.

7. The nonaqueous electrolyte air battery according to claim 6, including an ion-conducting medium which is interposed between the negative electrode and the solid electrolyte and does not contain the compound.

8. The nonaqueous electrolyte air battery according to claim 1,
wherein the negative electrode occludes and releases lithium, and
the nonaqueous electrolyte conducts lithium ions.

9. A method of use of a nonaqueous electrolyte air battery, including:
a negative electrode having a negative electrode active material, a first positive electrode including oxygen as a positive electrode active material, a nonaqueous electrolyte which is in contact with the first positive electrode and includes a compound having a structure containing a radical skeleton whose spin density measured by electron spin resonance spectroscopy is 10¹⁹ spins/g or more, and a second positive electrode which is in contact with the nonaqueous electrolyte and oxidizes the compound,
wherein the nonaqueous electrolyte air battery is discharged by using the negative electrode and the first positive electrode,
the compound is oxidized using the second positive electrode, and the nonaqueous electrolyte air battery is charged by the oxidized compound.

10. The method of use of a nonaqueous electrolyte air battery according to claim 9, wherein, after the compound is oxidized using the second positive electrode, the nonaqueous electrolyte air battery is held for a period of 2 to 24 hours, and the nonaqueous electrolyte air battery is charged by the oxidized compound.
